(19) United States
(12) Patent Application Publication
(10) Pub. No.: US 2007/0265770 A1
(43) Pub. Date: Nov. 15, 2007

(54) Mobile terminal apparatus, mobile terminal apparatus control method, mobile terminal apparatus control program, and recording medium for recording the mobile terminal apparatus control program

(75) Inventor: Koji Hirose, Tokyo (JP)

Correspondence Address: DRINKER BIDDLE & REATH (DC), 1500 K STREET, N.W., SUITE 1100, WASHINGTON, DC, 20005-1209, US

(73) Assignees: PIONEER CORPORATION; Increment P Corporation

(21) Appl. No.: 11/798,038

(22) Filed: May 9, 2007

(30) Foreign Application Priority Data
May 12, 2006 (JP) P2006-133592

(51) Int. Cl. G01C 21/00

(52) U.S. Cl. 701/202; 701/200; 701/213

(57) ABSTRACT

A mobile terminal apparatus, control method for a mobile terminal apparatus, control program for a mobile terminal apparatus, and a recording medium on which the control program for the mobile terminal apparatus are provided so that when utilizing a plurality of types of travel, by switching application programs to correspond with the type of travel used, the mobile terminal apparatus is able to perform support that corresponds to the type of travel. The mobile terminal apparatus comprises: sensors that detect state information for the mobile terminal apparatus that is moved by the type of travel; and a state-of-travel-judgment device that based on the state information detected by the sensors, takes all of the types of travel of the mobile terminal apparatus as candidates for the current type of travel, and determines the current type of travel used by giving weighting to each of the candidates, changing scores for the candidates and accumulating the total scores; where based on the type of travel that the state-of-travel-judgment device determines to be the current type of travel, an application program required by the mobile terminal apparatus for that type of travel is selected and that application program is executed.

### BACKGROUND OF THE INVENTION

1. Field of the Invention

The present invention relates to a mobile terminal apparatus.

2. Related Art

When traveling by automobile to a certain destination, an apparatus and technology are known by which it is possible to know the most optimal path to the destination without having to look at a map by simply entering the destination into a car-navigation apparatus that is equipped with a GPS (Global Positioning System) function. Also, when traveling by train, technology is known by which it is possible to know the train-line information by using a mobile information terminal such as a mobile phone to connect to a train-line guidance site over the Internet and downloading the train boarding/disembarkation time, fare or the like without having to check a time schedule for the boarding time, etc. Moreover, when traveling on foot, technology is known by which it is possible to know the best route to a destination by using a mobile phone to connect to a map site and download map data to the destination.

However, the apparatus and technology described above had the following problems. For example, when using a plurality of types of travel (bicycle, foot, motorcycle, train, automobile, airplane, ship, etc.) it is not possible to consistently receive navigation, so in order to perform support to correspond to various types of travel, the user must manually change the mode of information. Also, while receiving navigation information, it is not possible to obtain realtime information (train departure time, traffic congestion information, detour information, location of public toilets, etc.) based on the current time and current location.

### SUMMARY OF THE INVENTION

Taking the aforementioned problems into consideration, the object of the present invention is to provide a mobile terminal apparatus, mobile terminal apparatus control method, mobile terminal apparatus control program and recording medium for recording the mobile terminal apparatus control program capable of performing guidance support to correspond to the type of travel by changing the application program according to the type of travel even when using a plurality of type of travel.

The above object of the present invention can be achieved by a mobile terminal apparatus of the present invention. The mobile terminal apparatus is provided with: a state-information-detection device for detecting state information about the mobile terminal apparatus; a state-of-travel-judgment device for determining the state of travel of the mobile terminal apparatus based on state information that is detected by the state-information-detection device; a guidance-information-judgment device for determining which guidance information is necessary for the mobile terminal apparatus based on the state of travel of the mobile terminal apparatus that is determined by the state-of-travel-judgment device; and a notification device for notifying the mobile terminal apparatus of the guidance information that is determined to be necessary by the guidance-information-judgment device.

According to the present invention, the mobile terminal apparatus is constructed so that it comprises a built-in sensor that is capable of detecting the oscillation mode, so it is possible to detect vertical oscillation (amplitude, period, etc.), forward, rear, left and right oscillation of the mobile terminal apparatus, as well as the inclination, change in direction, and amount of movement of the mobile terminal apparatus. Moreover, from these values it is possible to automatically determine the mode of travel (automobile, walking, bicycle, motorcycle, train, airplane, boat, etc.) of the mobile terminal apparatus.

In one aspect of the present invention can be achieved by the mobile terminal apparatus of the present invention. The mobile terminal apparatus of the present invention is, wherein; the state-of-travel-judgment device gives weighting to state information that is detected by the state-information-detection device for each of a plurality of predetermined state-of-travel candidates over a predetermined period of time, changes the numerical values for the state information based on the weightings, and then determines the state of travel of the mobile terminal apparatus to be the state-of-travel candidate having the largest numerical value.

According to the present invention, determining the means of travel based on the sensor output is performed by weighting each of the candidates for the means of travel according to the state of travel of the mobile terminal apparatus, changing scores over a predetermined period of time and totaling those scores, so it is possible to determine the means of travel more accurately. Also, after these modes of travel have been determined, the mobile terminal apparatus is capable of selecting the most appropriate application for each mode of travel, and executing the appropriate application. As a result, each time the means of travel that is moving the mobile terminal apparatus changes, it is possible to automatically perform navigation that corresponds to that means of travel.

In another aspect of the present invention can be achieved by the mobile terminal apparatus of the present invention. The mobile terminal apparatus of the present invention is, wherein; the state-information-detection device comprises a plurality of state-information-detection units that detect state information; and the state-of-travel-judgment device gives weighting to state information that is detected by the plurality of state-information-detection units for each of a plurality of predetermined state-of-travel candidates over a predetermined period of time, changes the numerical values for the state information based on the weightings, and then determines the state of travel of the mobile terminal apparatus to be the state-of-travel candidate having the largest numerical value.

According to the present invention, determining the means of travel based on the sensor output is performed by weighting each of the candidates for the means of travel according to the state of travel of the mobile terminal apparatus, changing scores over a predetermined period of time and totaling those scores, so it is possible to determine the means of travel more accurately. Also, after these modes of travel have been determined, the mobile terminal apparatus is capable of selecting the most appropriate application for each mode of travel, and executing the appropriate application. As a result, each time the means of travel that is moving the mobile terminal apparatus changes, it is possible to automatically perform navigation that corresponds to that means of travel.

In further aspect of the present invention can be achieved by the mobile terminal apparatus of the present invention. The mobile terminal apparatus of the present invention is, wherein; the state-information-detection device comprises a position-information-detection unit that detects position information for the mobile terminal apparatus; and the state-of-travel-judgment device identifies the location on a map of where the mobile terminal apparatus is located based on position information that is detected by the position-information-detection unit, and gives weighting to the position information based on the identified location on the map where the mobile terminal apparatus is located for each of a plurality of predetermined state-of-travel candidates over a predetermined period of time, changes the numerical values for the state information based on the weightings, and then determines the state of travel of the mobile terminal apparatus to be the state-of-travel candidate having the largest numerical value.

According to the present invention, when the mobile terminal apparatus comprises internal map data, or when it is possible for the mobile terminal apparatus to received map data from the outside, construction is such that it is possible to determine the means of travel of the mobile terminal apparatus from the map data and the position information for the mobile terminal apparatus. Determining the means of travel based on map data and position information for the mobile terminal apparatus is performed by weighting each of the candidates for the means of travel according to the location of travel of the mobile terminal apparatus, changing scores over a predetermined period of time and totaling those scores, so it is possible to determine the means of travel more accurately. Therefore, each time the means of travel that is moving the mobile terminal apparatus changes according to the map data and position information of the mobile terminal apparatus, it becomes possible to automatically perform more accurate navigation that corresponds to that means of travel.

In further aspect of the present invention can be achieved by the mobile terminal apparatus of the present invention. The mobile terminal apparatus of the present invention is, wherein; the state-information-detection device further comprises a position-information-detection unit that detects position information for the mobile terminal apparatus; and the state-of-travel-judgment device identifies the location on a map of where the mobile terminal apparatus is located based on position information that is detected by the position-information-detection unit, and gives weighting to the position information based on the identified location on the map where the mobile terminal apparatus is located for each of a plurality of predetermined state-of-travel candidates over a predetermined period of time, changes the numerical values for the state information based on the weightings, calculates state-information values for which numerical values of the state information is changed, and calculates position-information values for which numerical values of the position information is changed, and then determines the state of travel of the mobile terminal apparatus to be the state-of-travel candidate having the largest numerical value for the calculated result.

According to the present invention, the mobile terminal apparatus combines determining the means of travel based on output from a sensor that is capable of detecting the oscillation mode, and determining the means of travel of the mobile terminal apparatus based on map data position information for the mobile terminal apparatus, so it is possible to more accurately determine the means of travel. As a result, each time the means of travel that is moving the mobile terminal apparatus changes, it is possible to automatically perform more accurate navigation that corresponds to the means of travel.

### BRIEF DESCRIPTION OF THE DRAWINGS

FIG. 1 is a block diagram showing an example of the construction of a mobile terminal apparatus S of an embodiment of the present invention.

FIGS. 2A, and 2B are drawings that shown the relationship between the mobile terminal apparatus S of an embodiment of the invention and direction of travel, where FIG. 2A is a drawing showing 2-dimensional axial directions, FIG. 2B is a drawing showing 3-dimensional axial directions, and a drawing showing rotational axial directions.

FIGS. 3A, 3B are tables for an embodiment of the invention that show the judgment criteria for determining the type of transportation used and the detected state, where FIG. 3A is a table showing the judgment criteria for a first judgment, and FIG. 3B is a table showing the judgment criteria for a second judgment.

FIG. 4 is a table that shows numerical scoring for quantifying the relationship between the type of travel and detected state in the first judgment of an embodiment of the invention.

FIG. 5 is a table that shows numerical scoring for quantifying the relationship between the type of travel and detected state in the second judgment of an embodiment of the invention.

FIG. 6A is a drawing for explaining the state of travel of an automobile as the type of travel of an embodiment of the invention. FIG. 6B is a table for quantifying the type of travel based on the first judgment of an embodiment of the invention. FIG. 6C is a table for quantifying the type of travel based on the second judgment of an embodiment of the invention. FIG. 6D is a table for quantifying the type of travel based on the first and second judgment of an embodiment of the invention.

FIG. 7 is a flowchart that shows the operation of a mobile terminal apparatus S of an embodiment of the invention.

### DETAILED DESCRIPTION OF THE PREFERRED EMBODIMENTS

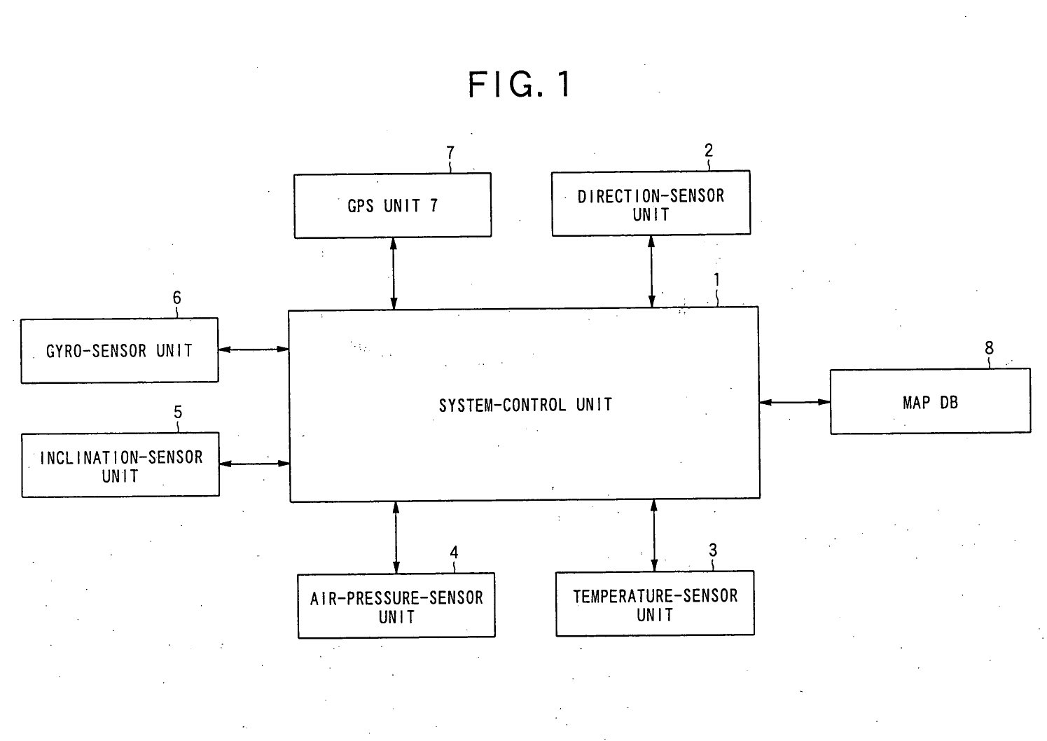

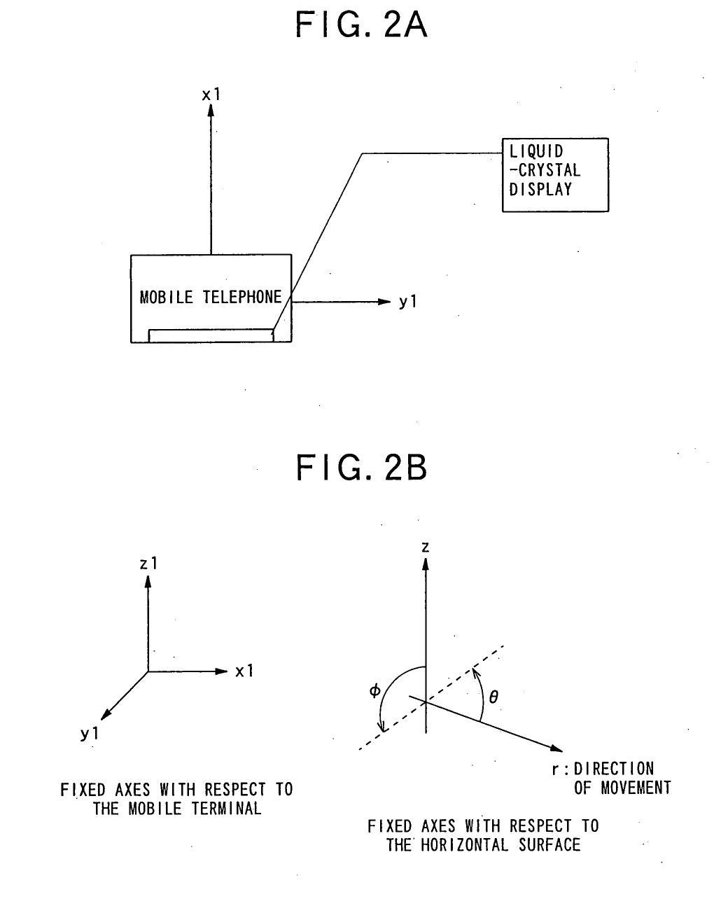

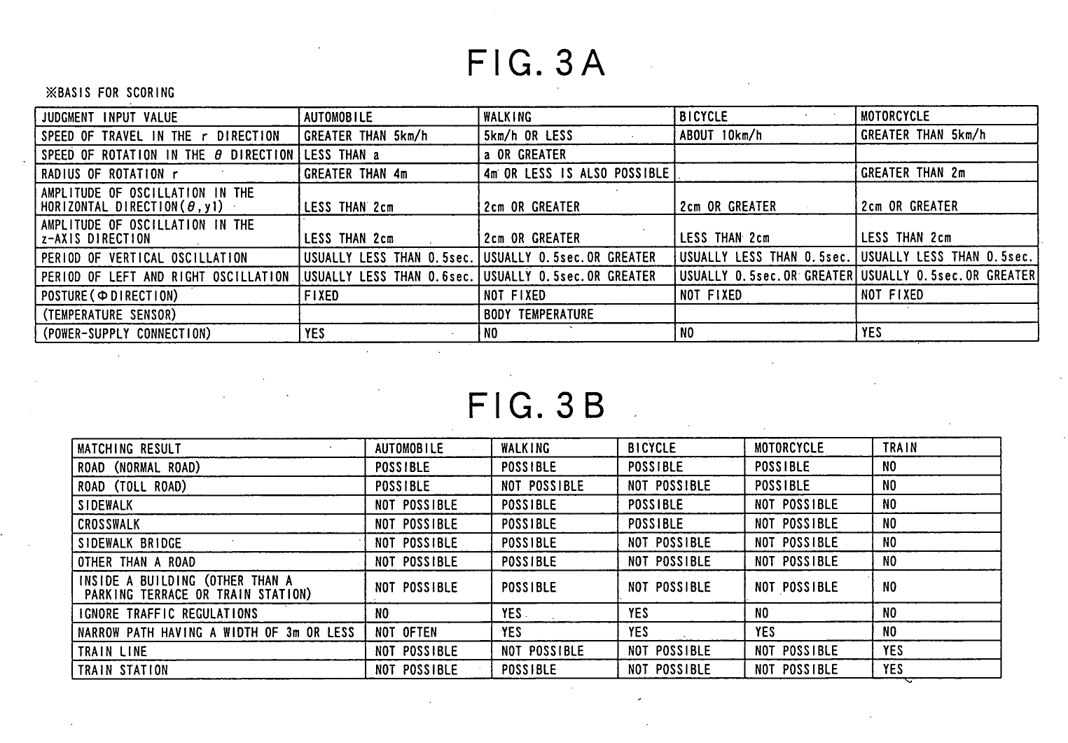

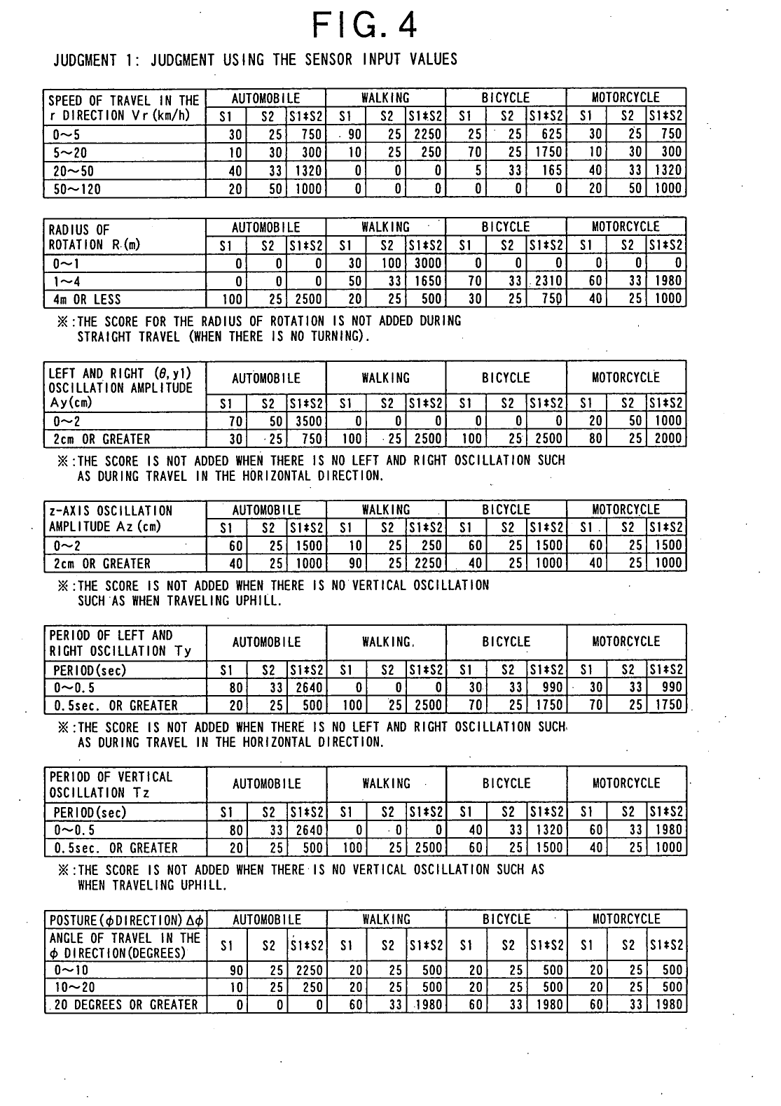

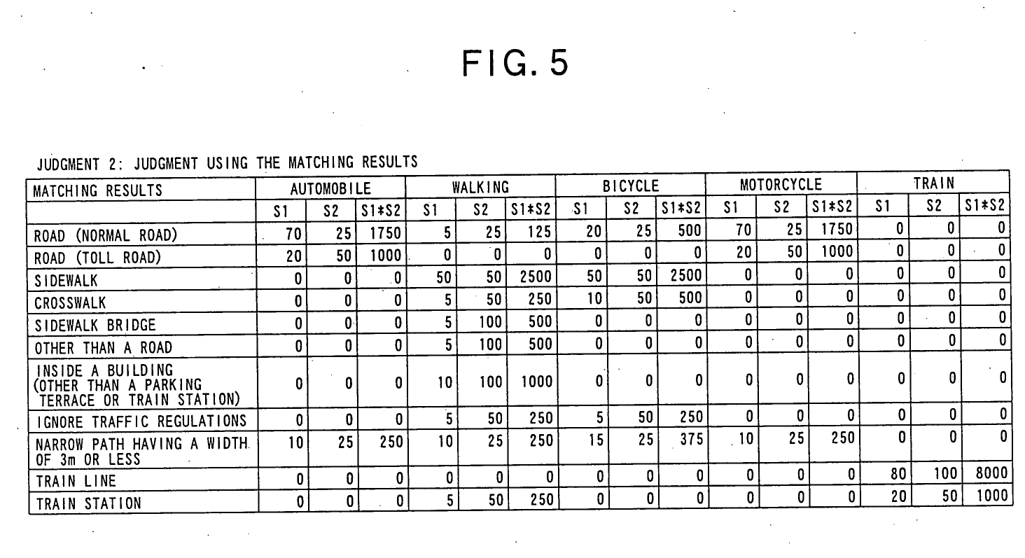

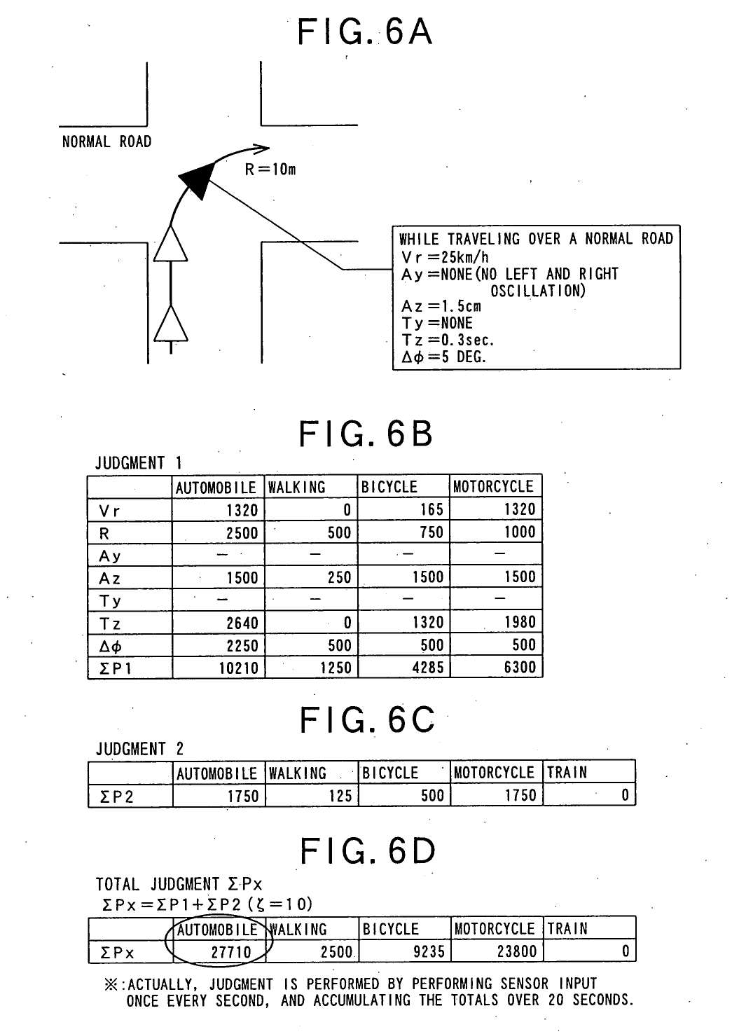

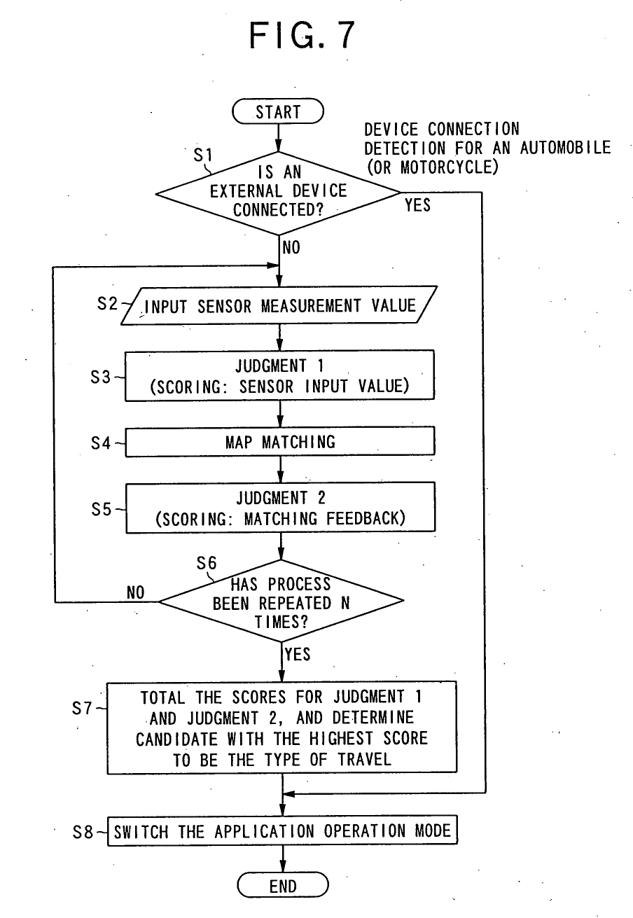

Next, the preferred embodiments of the invention will be explained based on FIG. 1 to FIG. 7. FIG. 1 is a block diagram showing an example of the construction of a mobile terminal apparatus S of an embodiment of the present invention. FIGS. 2A, and 2B are drawings that show the relationship between the mobile terminal apparatus S of an embodiment of the invention and direction of travel, where FIG. 2A is a drawing showing 2-dimensional axial directions, FIG. 2B is a drawing showing 3-dimensional axial directions, and a drawing showing rotational axial directions. FIGS. 3A, 3B are tables for an embodiment of the invention that show the judgment criteria for determining the type of transportation used and the detected state, where FIG. 3A is a table showing the judgment criteria for a first judgment, and FIG. 3B is a table showing the judgment criteria for a second judgment. FIG. 4 is a table that shows numerical scoring for quantifying the relationship between the type of travel and detected state in the first judgment of an embodiment of the invention. FIG. 5 is a table that shows numerical scoring for quantifying the relationship between the type of travel and detected state in the second judgment of an embodiment of the invention. FIG. 6A is a drawing for explaining the state of travel of an automobile as the type of travel of an embodiment of the invention. FIG. 6B is a table for quantifying the type of travel based on the first judgment of an embodiment of the invention. FIG. 6C is a table for quantifying the type of travel based on the second judgment of an embodiment of the invention. FIG. 6D is a table for quantifying the type of travel based on the first and second judgment of an embodiment of the invention. FIG. 7 is a flowchart that shows the operation of a mobile terminal apparatus S of an embodiment of the invention.

First, the mobile terminal apparatus S of an embodiment of the invention is explained based on FIG. 1.

The mobile terminal apparatus S of this embodiment comprises: a system-control unit 1 as state-of-travel-judgment device and guidance-information-judgment device; a direction-sensor unit 2, a temperature-sensor unit 3, an air-pressure sensor unit 4, a inclination-sensor unit 5 and a gyro-sensor unit 6 as state-information-detection device and a state-information-detection unit; a GPS unit 7 as state-information-detection device and position-information-detection device; and map DB (Data Base) as guidance information.

The system-control unit 1 comprises: a calculation unit (not shown in the figure); a memory unit (not shown in the figure) whose memory contents are not lost even when the power is turned OFF; a control unit (not shown in the figure); and a ROM unit (not shown in the figure) that stores programs and the like.

By way of the aforementioned calculation unit, the system-control unit 1 calculates the speed of travel and rotational velocity of the mobile terminal apparatus S, the amplitude of oscillation in each direction of the 3-dimensional axes, period of oscillation, temperature, and air pressure based on output information that is output from the direction-sensor unit 2, temperature-sensor unit 3, air-pressure-sensor unit 4, inclination-sensor unit 5 and gyro-sensor unit 6. Also, the system-control unit 1 calculates the position of the mobile terminal apparatus S on the map DB based on information that is output from the GPS unit 7.

As an example of a direction-sensor unit 2 is a magnetic-detection type direction sensor that comprises: a toroidal core (ring-shaped magnetic body) that is a magnetic body around which excitation winding (not shown in the figure) is wound; an inner coil (first winding) that is wound across the diameter around opposing sections of the toroidal core; and an outer coil (second winding) that is wound across the diameter around opposing sections of the toroidal core that are shifted 90 degrees from the aforementioned opposing sections.

In this direction sensor, when alternating current excitation occurs in the excitation winding in a state in which the magnetic field of the Earth He is not added in, the magnetic fluxes φ1, φ2 that pass through the opposing sections of the toroidal core are the same size in opposite directions, so the interlinked magnetic flux of the inner coil, which is the output winding, becomes zero, and output voltage V2 is not generated. Also, similarly output voltage V1 is not generated in the outer coil. However, when the magnetic field of the Earth He is applied to the inner coil from an orthogonal direction, the magnetic fluxes φ1, φ2 become asymmetrical, and an output voltage V2 is generated in the inner coil. At this time, the magnetic field of the Earth He is not inter inked with the outer coil so an output voltage V1 is not generated. However, when the direction sensor A is rotated around the vertical axis from this state, the output voltage V1 is generated, and as long as the direction sensor does not receive a magnetic effect from other than the magnetic field of the Earth He, the output voltages V1, V2 change according to a sine curve. When this kind of direction sensor A is installed in a mobile terminal apparatus S, the direction of travel θ of the mobile terminal apparatus can be expressed as θ=tan−1 (V1/V2). The direction of travel of a vehicle such as an automobile can be measured in this way.

Typically, the temperature sensors that are used in a temperature-sensor unit 3 are contact type or non-contact type. A contact type sensor comes in direct contact with the object and measures the temperature, and since it has simple construction, it is widely used. As typical examples of this kind of sensor are IC temperature gages that use the temperature characteristics of a platinum temperature measurement resistor, thermistor, thermocouple, or transistor. A non-contact type sensor measures infrared rays that are emitted from an object, and measures the temperature of the object according to the amount of infrared rays. A typical example of this kind of sensor is a thermopile.

An example of an air-pressure sensor that is used in an air-pressure sensor unit 4 is a semiconductor type air-pressure sensor. This sensor uses integrated circuit technology and is formed using a sealed silicon condenser, and records the change in distance between electrodes due to air pressure as the change in capacitance.

An example of an inclination-sensor unit 5 is an inclination sensor that uses a piezoresistance element. This inclination sensor is formed by processing a base, for example, and forming a weight in the center, then placing and fastening a silicon base on this base 1, and a plurality of piezoresistance elements are formed on the top surface of this silicon base, and when the sensor is tilted, the direction of gravity of the weight changes, and a bending stress acting on the silicon base occurs. The change in this stress is transmitted to the piezoresistance elements causing the resistance of the resistance elements to change. The sensor uses this change in resistance to detect the inclination of the sensor.

An example of a gyro-sensor unit 6 is a type of sensor that, by way of a piezoceramic oscillator, converts the coriolis force that occurs due to rotation to an electric signal, and detects a voltage that is proportional to the angular velocity. The output comprises reference voltage output and sensor output, where the reference voltage is output as a voltage that is about half the input voltage, and the sensor output is output as the aforementioned voltage that is proportional to the angular velocity. The sensor output is output based on the reference voltage.

The GPS unit 7 is able to determine the position of the mobile terminal apparatus S by receiving a radio signal from a satellite orbiting the Earth. A minimum number of three satellites is required for determining the position, however, when the position is determined by three satellites, it is only possible to determine the position on a plane. Information necessary for determining the position on a plane is the direction of the satellites, the altitude of the satellites and the distance to the satellites. In order to determine position in three dimensions, one more satellite and time become necessary. In other words, in order determine position in three dimensions, information from four satellites is necessary.

Next, FIGS. 2A to 2B show the relationship between the aforementioned sensor output and the direction of travel of the mobile terminal apparatus S.

FIG. 2A is a drawing showing 2-dimensional axial directions. When the mobile terminal apparatus S is inside a vehicle such as an automobile, and the direction y1 is the direction of travel, then the direction x1 indicates the width direction of the road that is orthogonal to the direction of travel. For example, in the case of a mobile telephone as the mobile terminal apparatus S, when the direction x1 is taken to the direction that is orthogonal to the screen of the liquid-crystal display, the screen of the liquid-crystal display faces the front glass of the automobile. Also, the direction y1 is the direction that is parallel with the screen of the liquid-crystal display, and indicates the direction of the side surface of the automobile.

FIG. 2B is a drawing showing 3-dimensional axial directions, where a z-axis direction is added to the axial directions of FIG. 2A. In the case of a mobile telephone as the mobile-terminal apparatus, the z-axis direction is the direction that is parallel to the screen of the liquid-crystal display and that indicates the direction of the ceiling of the automobile. In other words, it indicates the direction of vertical vibration of the automobile.

FIG. 2B is a drawing showing the rotational direction of the mobile terminal apparatus S. The direction θ is the direction of rotation in the X-Y plane with the Z-axis of the mobile terminal apparatus S as the center, For example, in the case of an automobile, it indicates detection of the speed of rotation of turning on a road (curve direction). The direction φ is the direction of rotation of the mobile terminal apparatus S when tilting from the z axis toward the y axis. For example, in a bicycle and motorcycle, the vehicle may tilt when the road turns, and it is possible to detect this tilt from the size of the direction FIGS. 3A and 3B are tables that show estimated scores for each type of travel for how much speed or change there is in each direction shown in FIG. 2 for each type of travel, such as an automobile, human (walking), bicycle, motorcycle, or the like that moves the mobile terminal apparatus S.

FIG. 3A shows the type of travel for moving the mobile terminal apparatus S along the horizontal axis, and the vertical axis shows the state such as the axis or angle of rotation in FIG. 2 that is calculated by the system-control unit 1 based on a signal that is output from the state-information-detection device. The reference values in the table are approximate reference values for determining each type of travel.

FIG. 3B shows the type of travel for moving the mobile terminal apparatus S along the horizontal axis, and the vertical axis indicates the location where the type of travel is detected. In each column of the table, the vertical axis indicates the possibility that the type of travel would exist in the location where the type of travel is detected. Scoring is performed in FIG. 5 based on this judgment criterion. This will be explained in detail using FIG. 5.

The scoring tables shown in FIG. 4 and FIG. 5 are stored in a memory unit or the like in the system-control unit 1. Also, based on the scoring tables shown in FIG. 4 and FIG. 5, the system-control unit 1 stores scores for each candidate of the travel state (automobile, walking, bicycle and motorcycle) based on the reference values shown in FIGS. 3A, 3B for signals output from the state-information-detection device. The scores are calculated in about 1 second. For example, when the scored sampling time interval is 1 second, then in 20 seconds, values that are accumulatively calculated 20 times for each item over 20 seconds are stored.

First, the case of the ‘speed of travel in the r direction’ in FIG. 3A and FIG. 4 will be explained. The r direction in FIG. 3A and FIG. 4 corresponds to the r direction (y1 direction) in FIG. 2, and indicates the direction of travel of the moving body as the type of travel that moves the mobile terminal apparatus S. For the direction of travel of the moving body, the system-control unit 1 calculates a value for determining the speed of the moving body based on a signal that is output from the state-information-detection device (this is not limited to output from just one state-detection device, but can be based on signals from a plurality of state-detection device).

In FIG. 3A, when the speed of travel of a moving body exceeds 5 km per hour, it is determined that there is a high possibility that the type of travel is an automobile, bicycle, or motorcycle. Also, when the speed of travel is less than 5 km per hour, it is determined that there is a high possibility that the type of travel is walking. Furthermore, when the moving body is traveling at a speed of about 10 km per hour, it is determined that there is a high possibility that the type of travel is a bicycle.

In FIG. 4, S1 and S2 that are displayed for each candidate for the type of travel (automobile, walking, bicycle and motorcycle) have the following meaning.

In the figure, the value S1 indicates the degree that it is possible of obtaining that state in each travel mode as a percentage. Also, S2 is the probability that it is possible to identify the mode of travel having that state. Based on the signals that are output from the information detection device for each state, the scores for the candidates of the state of travel are found from S1×S2.

Next, in FIG. 4, of the scoring for each moving body in regards to the ‘speed of travel in the r direction’, the case in which the moving body is assumed to be an automobile will be explained. First, the value S1 will be explained. When the control unit 1 calculates that the speed is 0 km to 5 km per hour, the control unit 1 determines that the degree of possibility that the moving body is an automobile is 30%. Also, when the control unit 1 calculates that the speed is 5 km to 20 km per hour, the control unit 1 determines that the degree of possibility that the moving body is an automobile is 10%. Moreover, when the control unit 1 calculates that the speed is 20 km to 50 km per hour, the control unit 1 determines that the degree of possibility that the moving body is an automobile is 40%. Furthermore, when the control unit 1 calculates that the speed is 50 km to 120 km per hour, the control unit 1 determines that the degree of possibility that the moving body is an automobile is 20%.

Next, the value S2 will be explained. When the control unit 1 calculates that the speed is 0 km to 5 km per hour, the control unit 1 determines that the probability that it is possible to identify the moving body as an automobile is 25%. Also, when the control unit 1 calculates that the speed is 5 km to 20 km per hour, the control unit 1 determines that the probability that it is possible to identify the moving body as an automobile is 30%. Moreover, when the control unit 1 calculates that the speed is 20 km to 50 km per hour, the control unit 1 determines that the probability that it is possible to identify the moving body as an automobile is 33%. Furthermore, when the control unit 1 calculates that the speed is 50 km to 120 km per hour, the control unit 1 determines that the probability that it is possible to identify the moving body as an automobile is 50%.

Also, based on the ‘speed of travel in the r direction’, the estimated score for estimating that the moving body is an automobile is calculated by the control unit 1 for each speed as shown in the S1*S2 column of FIG. 4, and is stored in the memory unit inside the control unit 1 as the result of the product of S1 and S2. When the control unit 1 calculates that the speed is 20 km to 50 km per hour, the estimated score for estimating that the moving body is an automobile that is calculated by the control unit 1 is 1320 points, which is the result of the product S1 (40%)×S2 (33%), and is stored in the memory unit of the control unit 1. These scores are just one example, and the scores are not limited to the scores listed here.

Next, of the scoring for each moving body in regards to the ‘speed of travel in the r direction’ in FIG. 4, the case in which the moving body is assumed to be a walking person will be explained. First, the value S1 will be explained. When the control unit 1 calculates that the speed is 0 km to 5 km per hour, the control unit 1 determines that degree of possibility that the moving body is a walking person is 90%. Also, when the control unit 1 calculates that the speed is 5 km to 20 km per hour, the control unit 1 determines that the degree of possibility that the moving body is a walking person is 10%. Moreover, when the control unit 1 calculates that the speed is greater than 20 km, the control unit 1 determines that the degree of possibility that the moving body is a walking person is 0%.

Next, the value S2 will be explained. When the control unit 1 calculates that the speed is 0 km to 5 km per hour, the control unit 1 determines that the probability that it is possible to identify the moving body as a walking person is 25%. Also, when the control unit 1 calculates that the speed is 5 km to 20 km per hour, the control unit 1 determines that the probability that it is possible to identify the moving body as a walking person is 25%. Moreover, when the control unit 1 calculates that the speed is greater than 20 km per hour, the control unit 1 determines that the probability that it is possible to identify the moving body as a walking person is 0%.

Also, based on the ‘speed of travel in the r direction’, the estimated score for estimating that the moving body is a walking person is calculated by the control unit 1 for each speed as shown in the S1*S2 column of FIG. 4, and is stored in the memory unit inside the control unit 1 as the result of the product of S1 and S2. These scores are just one example, and the scores are not limited to the scores listed here.

Similarly, estimated scoring for estimating that the moving body is an automobile or motorcycle is calculated by the control unit 1 as shown in the S1*S2 column of FIG. 4 for each speed, and the result of the product of S1 and S2 is stored in the memory unit inside the control unit 1.

Next, the ‘speed of rotation in the 0 direction’ in FIG. 3A and FIG. 4 will be explained. The θ direction in FIG. 3A corresponds to the θ direction in FIG. 2, and indicates the speed of rotation when the moving body, which is the means for moving the mobile terminal apparatus S, moves in the vertical direction with respect to another plane. The speed of rotation of the moving body is calculated as a value for the system-control unit 1 to perform determination based on a signal that is output from a state-information-detection device (this is not limited to the output from one state-detection device, and may be signals that are output from a plurality of state-detection device).

In FIG. 3A, when the speed of travel of the moving body is greater than about ‘a’ degrees/second (where the value of ‘a’ can be set to an arbitrary value), it is determined that the possibility of walking is high. This is because, in the case of walking, the radius of rotation is small (it is possible to change the direction of travel quickly, such as in a right angle), however, in the case of an automobile or the like, turning is limited by the distance between the front and rear wheels and it is not possible to turn quickly, so it becomes possible to identify the moving body by this kind of characteristic. This embodiment is for the case in which the ‘speed of rotation in the θ direction’ will not be calculated.

Next, the ‘radius of rotation r’ in FIG. 3A and FIG. 4 will be explained. The θ direction in FIG. 3A and FIG. 4 corresponds to the θ direction in FIG. 2, and the ‘radius of rotation r’ indicates the radius of rotation in the θ direction at a certain point of a moving body, which is the means of moving the mobile terminal apparatus. The system-control unit 1 calculates the radius of rotation r based on a signal that is output from a state-information-detection device.

In FIG. 3A, in the case of an automobile, at a minimum, the radius of rotation r is determined to be about 4 m or greater. Also, in the case of a motorcycle, at a minimum, the radius of rotation r is determined to be about 2 m or greater. Furthermore, in the case of walking, the radius of rotation r may be less than 1 m, and in that case, it is effective to make the score high.

Next, of the scoring of each of the moving bodies in regards to the ‘radius of rotation r’ in FIG. 4, the case of assuming the moving body to be an automobile will be explained.

First, the value S1 will be explained. When the control unit 1 calculates the radius of rotation r to be 0 m to 4 m, the control unit 1 determines that the degree of possibility that the moving body is an automobile is 0%. Also, when the control unit 1 calculates that the radius of rotation r is greater than 4 m, the control unit 1 determines that the degree of possibility that the moving body is an automobile is 100%.

Next, the value S2 will be explained. When the control unit 1 calculates that the radius of rotation r is 0 m to 4 m, the control unit determines that the probability that it is possible to identify the moving body as an automobile is 0%. Moreover, when the control unit 1 calculates that the radius of rotation is greater than 4 m, the control unit 1 determines that the probability that it is possible to identify the moving body as an automobile is 25%.

Also, the control unit 1 calculates an estimated score for the radius of rotation r for estimating that the moving body is an automobile as shown in the S1*S2 column of FIG. 4, and stores the result of the, product of S1 and S2 in the memory unit in the control unit 1. For example, when the control unit 1 calculates that the radius of rotation r is greater than 4 m, the control unit 1 calculates an estimated score of 2500 points, which is the result of the calculation S1 (100%)×S2 (25%), for estimating that the moving body is an automobile, and stores that score in the memory unit in the control unit 1.

Next, of the scoring for each moving body in regards to the ‘radius of rotation r’ in FIG. 4, the case of assuming that the moving body is a walking person will be explained. First, the value S1 will be explained. When the control unit 1 calculates that the radius of rotation r is 0 m to 1 m, the control unit 1 determines that the degree of the possibility that the moving body is a walking person is 30%. Also, when the control unit 1 calculates that the radius of rotation r is 1 m to 4 m, the control unit 1 determines that the degree of the possibility that the moving body is a walking person is 55%. Moreover, when the control unit 1 calculates that the radius of rotation r is greater than 4 m, the control unit 1 determines that the degree of the possibility that the moving body is a walking person is 20%.

Next, the value S2 will be explained. When the control unit 1 calculates that the radius of rotation r is 0 m to 1 m, the control unit 1 determines that the probability that the moving body can be identified as a walking person is 100%. When the control unit 1 calculates that the radius of rotation r is 1 m to 4 m, the control unit 1 determines that the probability that the moving body can be identified as a walking person is 33%. Moreover, when the control unit 1 calculates that the radius of rotation r is greater than 4 m, the control unit 1 determines that the probability that the moving body can be identified as a walking person is 25%

Also, based on the ‘radius of rotation r’, the control unit 1 calculates estimated scoring for estimating that the moving is a walking person for each speed, as shown in the S1*S2 column of FIG. 4, and stores the result of the product of S1 and S2 in the memory unit of the control unit 1. These scores are just an example, and are not limited to the scores listed here.

Similarly, the control unit 1 calculates an estimated score for estimating that the moving body is a bicycle or motorcycle for each ‘radius of rotation r’ as shown in the S1*S2 column of FIG. 4, and stores the result of the product S1 and S2 in the memory unit of the control unit 1.

Next, ‘left and right (θ, y1) amplitude of oscillation Ay’ in FIG. 3A and FIG. 4 will be explained. Left and right (θ, y1) in FIG. 3A and FIG. 4 corresponds to the θ direction and y1 direction in FIG. 2, and indicates the size of fluctuation to the left and right with respect to the direction of travel of the moving body, which is the means of moving the mobile terminal apparatus. The system-control unit 1 calculates the left and right (θ, y1) amplitude of oscillation Ay of the moving body (size of fluctuation to the left and right with respect to the direction of travel of the moving body).

In FIG. 3A, in the case of an automobile, left and right fluctuation with respect to the direction of travel is considered to be small, and is considered to be 2 cm or less. On the other hand, in the case of walking, bicycle and motorcycle, fluctuation to the left and right with respect to the direction of travel is considered to be larger than in the case of an automobile.

Also, in the case of walking, the possibility that the value will be 2 cm or greater is estimated to be larger than in the case of a bicycle and motorcycle.

Next, of the scoring for each moving body in regards to ‘left and right (θ, y1) amplitude of oscillation Ay’ in FIG. 4, the case of assuming that the moving body is an automobile will be explained.

First, the value S1 will be explained. When the control unit 1 calculates the left and right amplitude of oscillation Ay to be 0 cm to 2 cm, the control unit 1 determines that the degree of the possibility that the moving body is an automobile is 70%. Also, when the control unit 1 calculates that the left and right amplitude Ay is greater than 2 cm, the control unit determines that the degree of the possibility that the moving body is an automobile is 30%.

Next, the value S2 will be explained. When the control unit 1 calculates that the left and right amplitude of oscillation Ay is 0 cm to 2 cm, the control unit 1 determines that the probability that it is possible to identify the moving body as an automobile is 50%. When the control unit 1 calculates that the left and right amplitude of oscillation Ay is greater than 2 cm, the control unit 1 determines that the probability that it is possible to identify the moving body as an automobile is 25%.

Also, based on the ‘left and right amplitude of oscillation Ay’, the control unit 1 calculates an estimated score for estimating that the moving body is an automobile as shown in the S1*S2 column of FIG. 4, and stores the result of the product of S1 and S2 in the memory unit of the control unit 1. For example, when the control unit 1 calculates that the left and right amplitude of oscillation Ay is greater than 2 cm, the control unit 1 calculates the estimated score for estimating the moving body to be an automobile as 3500 points, which is the result of the calculation S1 (70%)×S2 (50%), and stores that score in the memory unit of the control unit 1.

Next, of the scoring for each moving body in regards to the ‘left and right amplitude of oscillation Ay” in FIG. 4, the case in which the moving body is assumed to be a walking person will be explained. First, the value S1 will be explained. When the control unit 1 calculates that the left and right amplitude of oscillation Ay is 0 cm to 2 cm, the control unit 1 determines that the degree of the possibility that the moving body is a walking person is 0%. When the control unit 1 calculates that the left and right amplitude of oscillation Ay is greater than 2 cm, the control unit 1 determines that the degree of the possibility that the moving body is a walking person is 100%.

Next, the value S2 will be explained. When the control unit 1 calculates that the left and right amplitude of oscillation Ay is 0 cm to 2 cm, the control unit 1 determines that the probability that it is possible to identify the moving body as a walking person is 0%. Also, when the control unit 1 calculates that the left and right amplitude of oscillation Ay is greater than 2 cm, the control unit 1 determines that the probability that it is possible to identify the moving body as a walking person is 25%.

Moreover, based on the ‘left and right amplitude of oscillation Ay’ with respect to the direction of travel of the moving body, the control unit 1 calculates an estimated score for estimating that the moving body is a walking person for each speed as shown in the S1*S2 column in FIG. 4, and stores the result of the product S1 and S2 in the memory unit of the control unit 1. For example, when the control unit 1 calculates that the left and right amplitude of oscillation Ay is greater than 2 cm, the control unit 1 calculates an estimated score 2500 points, which is the result of the calculation S1 (100%)×S2 (25%), for estimating that the moving body is a walking person, and stores that score in the memory unit in the control unit 1. These scores are just one example, so are not limited to those listed here.

Similarly, the control unit 1 calculates an estimated score for estimating that the moving body is a bicycle or motorcycle for each ‘left and right amplitude of oscillation Ay’ as shown in the S1*S2 column in FIG. 4, and stores the result of the product S1 and S2 in the memory unit in the control unit 1.

Next, the ‘z-axis amplitude of oscillation Az’ in FIG. 3A and FIG. 4 will be explained. The z-axis amplitude of oscillation Az in FIG. 3A and FIG. 4 corresponds to the amplitude of oscillation in the z-axis direction in FIG. 2, and indicates the size of fluctuation in the vertical direction with respect to the ground surface of the moving body, which is the means of moving the mobile terminal apparatus. Based on a signal that is output from a state-information-detection device, the system unit 1 calculates the z-axis amplitude of oscillation (size of the fluctuation in the vertical direction with respect to the ground surface of the moving body).

In FIG. 3A, in the case of walking, the size of fluctuation in the vertical direction with respect to the ground surface is considered to be comparatively large, and is taken to be greater than 2 cm. On the other hand, in the case of an automobile, bicycle or motorcycle, the size of fluctuation in the vertical direction with respect to the ground surface is considered to be comparatively small (less than 2 cm).

Next, of the scoring of each moving body in regards to the ‘z-axis amplitude of oscillation Az’ in FIG. 4, the case of assuming that the moving body is an automobile will be explained.

First, the value S1 will be explained. When the control unit 1 calculates that the z-axis amplitude of oscillation Az is 0 cm to 2 cm, the control unit 1 determines that the degree of the possibility that the moving body is an automobile is 60%. Also, when the control unit 1 calculates that the z-axis amplitude of oscillation Az is greater than 2 cm, the control unit 1 determines that the degree of the possibility that the moving body is an automobile is 40%.

Next, the value S2 will be explained. When the control unit 1 calculates that the z-axis amplitude of oscillation Az is 0 cm to 2 cm, the control unit 1 determines that the probability that it is possible to identify the moving body as an automobile is 25%. When the control unit 1 calculates that the z-axis amplitude of oscillation Az is greater than 2 cm, the control unit 1 determines that the probability that it is possible to identify the moving body as an automobile is 25%.

Also, based on the ‘z-axis amplitude of oscillation Az’, the control unit 1 calculates an estimated score for estimating that the moving body is an automobile, as shown in the S1*S2 column of FIG. 4 for the z-axis amplitude of oscillation Az, and stores the result of the product S1 and S2 in the memory unit in the control unit 1. For example, when the control unit 1 calculates that the z-axis amplitude of oscillation Az is 0 to 2 cm, the control unit calculates an estimated score of 1500 points, which is the result of the calculation S1 (60%)×S2 (25%), for estimating that the moving body is an automobile, and stores that score in the memory unit in the control unit 1.

Similarly, the control unit 1 calculates an estimated scored for estimating that the moving body is a walking person, bicycle or motorcycle as shown in the S1*S2 column of FIG. 4 for each ‘z-axis amplitude of oscillation Az’, and stores the result of the product S1 and S2 in the memory unit in the control unit 1.

Next, the ‘left and right oscillation period Ty’ in FIG. 3A and FIG. 4 will be explained. The ‘left and right oscillation period Ty’ in FIG. 3A and FIG. 4 corresponds to the y1 direction in FIG. 2, and indicates the period of fluctuation to the left and right with respect to the direction of travel of the moving body, which is the means that moves the mobile terminal apparatus S. Based on a signal that is output from the state-information-detection device, the system-control unit 1 calculates the left and right oscillation period Ty (period of fluctuation to the left and right with respect to the direction of travel of the moving body) of the moving body.

In FIG. 3A, in the case of an automobile, the period of fluctuation to the left and right with respect to the direction of travel is considered to be small, and is considered to be less than 0.5 seconds. On the other hand, in the case of walking, a bicycle and a motorcycle, the period of fluctuation to the left and right with respect to the direction of travel is considered to be larger than in the case of an automobile.

Next, of the scoring for each moving body in regards to the ‘left and right oscillation period Ty’ in FIG. 4, the case of assuming that the moving body is an automobile will be explained.

First, the value S1 will be explained. When the control unit 1 calculates that the left and right oscillation period Ty is 0 to 0.5 seconds, the control unit 1 determines that the degree of the possibility that the moving body is an automobile is 80%. Also, when the control unit 1 calculates that the left and right oscillation period Ty is greater than 0.5 seconds, the control unit 1 determines that the degree of the possibility that the moving body is an automobile is 20%.

Next, the value S2 will be explained. When the control unit 1 calculates that the left and right oscillation period Ty is 0 to 0.5 seconds, the control unit 1 determines that the probability that it is possible to identify the moving body as an automobile is 33%. When the control unit 1 calculates that the left and right oscillation period Ty is greater than 0.5 seconds, the control unit 1 determines that the probability that it is possible to identify the moving body as an automobile is 25%.

Also, based on the ‘left and right oscillation period Ty’, the control unit 1 calculates an estimated score for estimating that the moving body is an automobile as shown in the S1*S2 column of FIG. 4 for the left and right oscillation period, and stores the result of the product S1 and S2 in the memory unit in the control unit 1. For example, when the control unit 1 calculates that the left and right oscillation period Ty is 0 to 0.5 seconds, the control unit 1 calculates an estimated score of 2640 points, which is the result of the calculation S1 (80%)×S2 (33%), for estimating that the moving body is an automobile, and stores that score in the memory unit in the control unit 1.

Similarly, the control unit 1 calculates an estimated score for estimating that the moving body is a walking person, a bicycle or a motorcycle as shown in the S1*S2 column of FIG. 4 for each ‘left and right oscillation period Ty’, and stores the result of the product of S1 and S2 in the memory unit in the control unit 1.

Next, the ‘vertical oscillation period Tz’ in FIG. 3A and FIG. 4 will be explained. The vertical oscillation in FIG. 3A and FIG. 4 corresponds to the z-axis direction in FIG. 2 and indicates the size of the oscillation period in the vertical direction with respect to the ground surface of the moving body, which is the means that moves the mobile terminal apparatus S. Based on a signal that is output from the state-information-detection device, the system-control unit 1 calculates the vertical oscillation period of the moving body (oscillation period with respect to the ground surface of the moving body).

In FIG. 3A, in the case of walking, the period of vertical oscillation with respect to the ground surface is considered to be comparatively large, and is taken to be 0.5 seconds or more. On the other hand, in the case of an automobile or motorcycle, the period of vertical oscillation with respect to the ground surface is considered to be comparatively small (less than 0.5 seconds). In the case of walking, the vertical oscillation with respect to the ground surface becomes large due to up and down motion of the legs, and since the walking speed is s low, there is a tendency for the period of vertical oscillation to become large. Also, in the case of an automobile, bicycle or motorcycle, the portion that comes in contact with the ground is a round tire, so vertical oscillation becomes small, and since the speed of an automobile, bicycle or motorcycle is fast, the period of vertical oscillation becomes short.

Next, of the scoring for each moving body with regards to the ‘vertical oscillation period Tz’ in FIG. 4, the case in which the moving body is assumed to be an automobile will be explained.

First, the value S1 will be explained. When the control unit 1 calculates that the vertical oscillation period Tz is 0 to 0.5 seconds, the control unit 1 determines that the degree of the possibility that the moving body is an automobile is 80%. Also, when the control unit 1 calculates that the vertical oscillation period Tz is greater than 0.5 seconds, the control unit 1 determines that the degree of the possibility that the moving body is an automobile is 20%.

Next, the value S2 will be explained. When the control unit 1 calculates that the vertical oscillation period is 0 to 0.5 seconds, the control unit 1 determines that the probability that it is possible to identify the moving body as an automobile is 33%. When the control unit 1 calculates that the vertical oscillation period Tz is greater than 0.5 seconds, the control unit 1 determines that the probability that it is possible to identify the moving body as an automobile is 25%,

Also, based on the ‘vertical oscillation period Tz’, the control unit 1 calculates an estimated score for estimating that the moving body is an automobile as shown in the S1*S2 column of FIG. 4 for the vertical oscillation period Tz, and stores the product of S1 and S2 in the memory unit in the control unit 1. For example, when the control unit 1 calculates that the vertical oscillation period Tz is 0 to 0.5 seconds, the control unit 1 calculates an estimated score of 2640 points, which is the result of the calculation S1 (80%)×S2 (33%), for estimating that the moving body is an automobile, and stores that score in the memory unit in the control unit 1.

Similarly, the control unit 1 calculates an estimated score for estimating that the moving body is a walking person, a bicycle or a motorcycle as shown in the S1*S2 column of FIG. 4 for each ‘vertical oscillation period Tz’, and stores the result of the product S1 and S2 in the memory unit in the control unit 1.

Next, the ‘posture (φ direction) Δφ’ in FIG. 3A and FIG. 4 will be explained. In FIG. 3A and FIG. 4, the ‘posture (φ direction) Δφ’ corresponds with the incline in the θ direction, and indicates the amount of incline (degrees) in the forward or rear direction with respect to the direction of travel of the moving body, which is the means of moving the mobile terminal apparatus. Based on a signal that is output from the state-information device, the system-control unit 1 calculates the incline in the φ direction of the moving body (forward or rear inclination angle with respect to the direction of travel of the moving body).

In FIG. 3A, in the case of an automobile, the mobile terminal apparatus S is often fixed (the user carries the mobile terminal apparatus S in a breast pocket, or the mobile terminal apparatus S is placed in a predetermined position on the dashboard of the automobile), so it can be considered that there is not much inclination in the φ direction. However, in the case of walking, a bicycle or a motorcycle, it can be considered that the user often carries the mobile terminal apparatus S in a breast pocket, so the inclination in the φ direction of the moving body can be considered to be large compared with in the case of an automobile.

Next, of the scoring for each moving body in regards to the ‘posture (φ direction) Δφ’ in FIG. 4, the case in which the moving body is assumed to be an automobile will be explained.

First, the value S1 will be explained. When the control unit 1 calculates the posture (φ direction) Δφ to be 0 to 10 degrees, the control unit 1 determines that the degree of the possibility that the moving body is an automobile is 90%. Also, when the control unit 1 calculates the posture (φ direction) Δφ to be 10 to 20 degrees, the control unit 1 determines that the degree of the possibility that the moving body is an automobile is 10%. Moreover, when the control unit 1 calculates the posture (φ direction) Δφ to be greater than 20 degrees, the control unit 1 determines that the degree of the possibility that the moving body is an automobile is 0%.

Next, the value S2 will be explained. When the control unit 1 calculates the posture (φ direction) Δφ to be 0 to 10 degrees, the control unit 1 determines that the probability that it is possible to identify the moving body as an automobile is 25%. When the control unit 1 calculates the posture (φ direction) Δφ to be 10 to 20 degrees, the control unit 1 determines that the probability that it is possible to identify the moving body as an automobile is 25%. Moreover, when the control unit 1 calculates the posture (φ direction) Δφ to be greater than 20 degrees, the control unit 1 determines that probability that it is possible to identify the moving body as an automobile is 0%.

Also, based on the ‘posture (φ direction) Δφ’, the control unit 1 calculates an estimated score for estimating that the moving body is an automobile as shown in the S1*S2 column of FIG. 4 for the posture (φ direction) Δφ, and stores the result of the product of S1 and S2 in the memory unit in the control unit 1. For example, when the control unit 1 calculates that the posture (φ direction) Δφ is 0 to 10 degrees, the control unit 1 calculates an estimated score of 2250 points, which is the result of the calculation S1 (90%)×S2 (25%), for estimating that the moving body is an automobile, and stores that score in the memory unit in the control unit 1.

Similarly, the control unit 1 calculates an estimated score for estimating that the moving body is a walking person, a bicycle or a motorcycle as shown in the S1*S2 column of FIG. 4 for each ‘posture (φ direction) Δφ’, and stores the result of the product S1 and S2 in the memory unit in the control unit 1.

These scores are just one example, and are not limited to the scores shown here. Also, it is possible to apply this kind of scoring to other types of travel as well, such as a train, airplane, ship or the like.

Next, FIG. 5 will be used to explain scoring assigned to each type of travel using a GPS unit 7 and map DB. The map DB is stored in advance in the memory unit inside the mobile terminal apparatus S. However, it is also possible to use wireless communication or wired communication to download a map from the outside.

As shown in FIG. 4, in FIG. 5 the cases of an automobile, walking, bicycle and motorcycle as types of travel will be explained.

Based on position information that is output from the GPS unit 7 and information from the map DB, the system-control unit 1 determines what position the mobile terminal apparatus S is currently in.

Here, scoring for the case in which as a result of the determination by the system-control unit 1, it is determined that the mobile terminal apparatus S is on a road (general road) will be explained.

Similar to the case shown in FIG. 4 in which the score is estimated based on a value that is obtained from state-information-detection device such as the sensor, the value S1 is the degree of the possibility that a state is taken for each mode of travel indicated as a percentage %. Also, the value S2 is the probability that it is possible to identify the mode of travel having that state. Based on a signal that is output from each state-information-detection device, scoring for the candidates as the state of travel is found from S1×S2.

The possibility that a bicycle and motorcycle are traveling over a road is considered to be high, so the value S1 for both a bicycle and motorcycle is 70%, and the value S2 is 25%. In this case, the score, which is expressed as S1×S2, that the moving body is a bicycle or motorcycle is 70×25=1750 points. Also, a walking person in not generally considered to be traveling on a road, so the value S1 is 5% and the value S2 is 25%. In this case, the score, which is expressed as S1×S2, that the moving body is a bicycle or motorcycle is 20×25=500 points. Also, it is not very probable that a train will travel over a road, so the value S1 is 0%, and the value S2 is 0%. In this case, the score, which is expressed as S1×S2, that the moving body is a train is 0×0=0 points.

Next, scoring for the case in which as a result of the determination by the system-control unit 1, it is determined that the mobile terminal apparatus S is on a road (toll road) will be explained.

It is considered that there is a possibility that an automobile and motorcycle could be traveling on a toll road, so the value S1 for both an automobile and a motorcycle is 20%, and value S2 is 50%. In this case, the score, which is expressed as S1×S2, that the moving body is an automobile or motorcycle is 20×50=1000 points. Also, it is considered to be not likely that a walking person, bicycle or train will be traveling on a toll road, so the value S1 is 0% and the value S2 is 0%. In this case, the score, which is expressed as S1×S2, that the moving body is a walking person, a bicycle or a train is 0×0=0 points.

Next, scoring for the case in which as a result of the determination by the system-control unit 1, it is determined that the mobile terminal apparatus S is on a sidewalk will be explained.

It is considered that there is a possibility that a walking person and bicycle would be traveling on a sidewalk, so the value S1 for a walking person and a bicycle is 50%, and the value S2 is 50%. In this case, the score, which is expressed as S1×S2, that the moving body is a walking person or a bicycle is 50×50=2500 points. Also, it is considered to be unlikely that an automobile, motorcycle or train would be traveling on a sidewalk, so the value S1 is 0% and the value S2 is 0%. In this case, the score, which is expressed as S1×S2, that the moving body is an automobile, a motorcycle or a train is 0×0=0 points.

Next, scoring for the case in which as a result of the determination by the system-control unit 1, it is determined that the mobile terminal apparatus S is crossing a crosswalk will be explained.

It is considered to be possible that a walking person would be crossing a crosswalk, so the value S1 is 5%, and the value S2 is 50%. In this case, the score, which is expressed as S1×S2, that the moving body is a walking person is 5×50=250 points. Also, it is considered possible that a bicycle would be crossing a crosswalk, so the value S1 is 10% and the value S2 is 50%. In this case, the score, which is expressed as S1×S2, that the moving body is a bicycle is 10×50=500 points. However, it cannot normally be considered that an automobile, a motorcycle or a train would be crossing a crosswalk, so the value S1 is 0%, and the value S2 is 0%. In this case, the score, which is expressed as S1×S2, that the moving body is an automobile, a motorcycle or a train is 0×0=0 points.

Next, scoring for the case in which as a result of the determination by the system-control unit 1, it is determined that the mobile terminal apparatus S is crossing over a sidewalk bridge will be explained.

It is considered to be possible that a walking person would be crossing over a sidewalk bridge, so the value S1 is 5%, and the value S2 is 100%. In this case, the score, which is expressed as S1×S2, that the moving body is a walking person is 5×100=500 points. However, it cannot normally be considered that an automobile, a bicycle, a motorcycle or a train would be crossing over a sidewalk bridge, so the value S1 is 0%, and the value S2 is 0%. In this case, the score, which is expressed as S1×S2, that the moving body is an automobile, a bicycle, a motorcycle or a train is 0×0=0 points.

Next, scoring for the case in which as a result of the determination by the system-control unit 1, it is determined that the mobile terminal apparatus S is traveling over something other than a road will be explained.

It is considered to be possible that a walking person could be traveling through a public square, a park or the like and not a road, so the value S1 is 5% and the value S2 is 100%. In this case, the score, which is expressed as S1×S2, that the moving body is a walking person is 5×100=500 points. However, it cannot normally be considered that an automobile, a bicycle, a motorcycle or a train would be traveling trough a public square, a park or the like, so the value S1 is 0%, and the value S2 is 0%. In this case, the score, which is expressed as S1×S2, that the moving body is an automobile, a bicycle, a motorcycle or a train is 0×0=0 points.

Next, scoring for the case in which as a result of the determination by the system-control unit 1, it is determined that the mobile terminal apparatus S is traveling inside a building (other than a parking terrace or a train station) will be explained.

It is considered to be possible that a walking person could be traveling inside a building (other than a parking terrace or train station), so the value S1 is 10% and the value S2 is 100%. In this case, the score, which is expressed as S1×S2, that the moving body is a walking person is 10×100=1000 points. However, it cannot normally be considered that an automobile, a bicycle, a motorcycle or a train would be traveling inside a building (other than a parking terrace or train station), so the value S1 is 0%, and the value S2 is 0%. In this case, the score, which is expressed as S1×S2, that the moving body is an automobile, a bicycle, a motorcycle or a train is 0×0=0 points.

Next, scoring for the case in which as a result of the determination by the system-control unit 1, it is determined that the mobile terminal apparatus S is traveling and ignoring traffic regulations will be explained.

In the case of traveling and ignoring traffic regulations, for example, a case in which the mobile terminal apparatus S is traveling in the wrong direction over a one-way road, or a case in which the mobile terminal apparatus S is traveling on the wrong side of the road, can be considered.

It is considered to be possible that a walking person could be traveling and ignoring traffic regulations, so the value S1 is 5% and the value S2 is 50%. In this case, the score, which is expressed as S1×S2, that the moving body is a walking person is 5×50=250 points. Also, it is considered to be possible that a bicycle could be traveling and ignoring traffic regulations, so the value S1 is 5%, and the value S2 is 50%. In this case, the score, which is expressed as S1×S2, that the moving body is a bicycle is 5×50=250 points. However, it cannot normally be considered that an automobile, a motorcycle or a train would be traveling and ignoring regulations, so the value S1 is 0%, and the value S2 is 0%. In this case, the score, which is expressed as S1×S2, that the moving body is an automobile, a motorcycle or a train is 0×0=0 points.

Next, scoring for the case in which as a result of the determination by the system-control unit 1, it is determined that the mobile terminal apparatus S is traveling a narrow path having a width of 3 m or less will be explained.

In the case of an automobile, the possibility of traveling on a narrow path having a width of 3 m or less is low. Also, in the case of a motorcycle, the possibility of traveling on a narrow path having a width of 3 m or less is low, however, not totally impossible. On the other hand, in the case of a walking person or a bicycle, there is a possibility of traveling on a narrow path having a width of 3 m or less.

It is considered to be possible that an automobile, a walking person or motorcycle could be traveling on a narrow path having a width of 3 m or less, so the value S1 is 10%, and the value S2 is 25%. In this case, the score, which is expressed as S1×S2, that the moving body is an automobile, a walking person or a motorcycle is 10×25=250 points. It is also considered to be possible that a bicycle could be traveling on a narrow path having a width of 3 m or less, so the value S1 is 15%, and the value S2 is 25%. In this case, the score, which is expressed as S1×S2, that the moving body is a bicycle is 15×25=375 points. However, it cannot normally be considered that a train would be traveling on a narrow path having a width of 3 m or less, so the value S1 is 0%, and the value S2 is 0%. In this case, the score, which is expressed as S1×S2, that the moving body is a train is 0×0=0 points.

Next, scoring for the case in which as a result of the determination by the system-control unit 1, it is determined that the mobile terminal apparatus S is traveling on a train line will be explained.

A train normally travels over a train line, so the value S1 is 80%, and the value S2 is 100%. In this case, the score, which is expressed as S1×S2, that the moving body is a train is 80×100=8000 points. The possibility that the moving body is an automobile, a walking person, a bicycle or a motorcycle is calculated as being zero, so the score, which is expressed as S1×S2, that the moving body is an automobile, a walking person, a bicycle or a motorcycle is 0×0=0 points.

Next, scoring for the case in which as a result of the determination by the system-control unit 1, it is determined that the mobile terminal apparatus S is stopped at a train station or traveling through a train station will be explained.

A train normally travels over a train line and stops at or passes through a train station, so the value for S1 is 20%, and the value for S2 is 50%. In this case, the score, which is expressed as S1×S2, that the moving body is a train is 20×50=1000 points. Also, there is a possibility that a walking person could be at a train station, so the value S1 is 5%, and the value S2 is 50%. In this case, the score, which is expressed as S1×S2, that the moving body is a walking person is 5×50=250 points.

As described above, based on the position information on the left side of FIG. 5 in the map DB of the mobile terminal apparatus S that was known through the GPS unit 7, the scores in the columns for an automobile, a walking person, a bicycle and a motorcycle are calculated at preset intervals of time (for example 1 second intervals) over a period of time of 20 seconds.

For example, at a certain time, when it is determined that the place where the mobile terminal apparatus S is located is a toll road, then as described above, a score of 1000 points is recorded in the automobile column, a score of 0 points is recorded in the walking column, a score of 0 points is recorded in the bicycle column and a score of 100 points is recorded in the motorcycle column.

Furthermore, after 1 second, for example, when it is determined that the place where the mobile terminal apparatus S is located is a toll road, then 1000 points are further added to the previous 1000 points in the automobile column, and a total of 2000 points is recorded. Also, 0 points are further added to the previous 0 points in the walking column, so a total of 0 points is recorded. Moreover, 1000 points are further added to the previous 1000 points in the motorcycle column, and a total of 2000 points is recorded.

In this way, based on the place where the mobile terminal apparatus S is located over a preset amount of time. Scores that are shown in FIG. 5 in the automobile column, walking column, bicycle column and motorcycle column are calculated.

FIGS. 6A to 6D will be used to explain a detailed example of the case in which the moving body is an automobile.

FIG. 6A shows the case in which the moving body is an automobile. The automobile is traveling over a normal road at a speed of 25 km per hour and making a right turn at an intersection with the radius of the curve being 10 m. The left and right amplitude of oscillation with respect to the direction of travel is 0, the z-axis amplitude of oscillation Az is 1.5 cm, the left and right oscillation period Ty is 0, the vertical oscillation period Tz is 0.3 sec., and the posture (φ direction) Δφ is 5 degrees.

The table for judgment 1 in FIG. 6B shows values that were calculated under the conditions described above based on judgment 1 shown in FIG. 4 for an automobile, a walking person, a bicycle and motorcycle as the moving body. The summations ΣP1 are values for the case in which scores for Vr, R, Ay, Az, Ty, Tz and Δφ for each moving body (automobile, walking person, bicycle and motorcycle) were measured one time. (The summation calculation is normally performed at 1-second intervals over a time period of 20 seconds.) The summation ΣP1 for an automobile is 10210 points. The summation ΣP1 for a walking person is 1250 points. The summation ΣP1 for a bicycle is 4235 points. The summation ΣP1 for a motorcycle is 6300 points.

In judgment 1 the summation calculation of the most suitable points for each state of travel is performed every second over a period of 20 seconds, with the state having the highest amount of points taken to be the state of travel. When there are states having the same number of points, it is assumed that there has been no change in the state of travel since the previous calculation.

In FIG. 6B, the system-control unit 1 determines that an automobile has the highest number of points, so determines that the state of travel is an automobile.

The table for judgment 2 shown in FIG. 6C shows values that are calculated based on judgment 2 shown in FIG. 5 for an automobile, a walking person, a bicycle and a motorcycle as the moving body. The summations ΣP2 are values of accumulated points that were calculated for each moving body (automobile, walking person, bicycle and motorcycle) based on the items: a road (normal road), road (toll road), road (normal road), sidewalk, crosswalk, sidewalk bridge, place other than a road, in a building (except a parking terrace or train station), travel with no regard to regulation, traveling over a narrow path having a width of 3 m or less, train line, and train station. The summation ΣP2 for an automobile is 1750 points. The summation ΣP2 for a walking person is 125 points. The summation ΣP2 for a bicycle is 500 points. The summation ΣP2 for a motorcycle is 1750 points. The summation ΣP2 for a train is 0 points.

In judgment 2 the summation calculation of the most suitable points for each state of travel is performed every second over a period of 20 seconds, with the state having the highest amount of points taken to be the state of travel. However, FIG. 6C shows the calculated values for only one time. When there are states having the same number of points, it is assumed that there has been no change in the state of travel since the previous calculation.

In FIG. 6C, the system-control unit 1 determines that the highest number of points is for an automobile, and determines that the state of travel is an automobile.

In order to accurately calculate the most suitable number of points when using both judgment 1 and judgment 2 to determine the state of travel, a weighting is given to the summation ΣP2, which is the result of judgment 2, by multiplying the summation ΣP2 by an appropriate value. When performing the determination in FIG. 6D using both judgment 1 and judgment 2, the summation ΣP2 is multiplied by 10 as a weighting factor. As a result, the points (ΣPx) calculated using both judgment 1 and judgment 2 are 27710 points for an automobile, 2500 points for a walking person, 9235 points for a bicycle, 23800 points for a motorcycle, and 0 points for a train.

As a result, the system-control unit 1 determines that the state of travel with the highest number of points is an automobile.

As was described above, the system-control unit 1 calculates values that were calculated for each state of travel shown in FIG. 4 and to which weighting has been given to the total points in the automobile column, walking column, bicycle column and motorcycle column, and values that were calculated based on the places where the mobile terminal apparatus S is located as shown in FIG. 5 and to which weighting has been given to the total points in the automobile column, walking column, bicycle column, motorcycle column and train column.

The system-control unit 1 compares the total points for an automobile, walking, bicycle, motorcycle and train as candidates for the state of travel. As a result of that comparison, the system-control unit 1 determines that the candidate having the highest number of total points is the means of travel that is moving the mobile terminal apparatus S.

After that, the system-control unit lactivates an application program that corresponds to the means of travel that is moving the mobile terminal apparatus, and provides map information to the user that is suitable to that means of travel.

For example, when the system-control unit 1 determines that the means of travel is an automobile, the mobile terminal apparatus executes the application that corresponds to navigation for an automobile. Also, when the system-control unit 1 determines that the means of travel is a walking person, the mobile terminal apparatus executes the application that corresponds to navigation for a walking person. Moreover, when the system-control unit 1 determines that the means of travel is a bicycle, the mobile terminal apparatus executes the application that corresponds to navigation for a bicycle. Furthermore, when the system-control unit 1 determines that the means of travel is a motorcycle, the mobile terminal apparatus executes the application that corresponds to navigation for a motorcycle.

These application programs can be stored beforehand in the memory unit of the mobile terminal apparatus S. Also, it is possible for the mobile terminal apparatus to execute an application by accessing through wireless or wired access an information processing unit (for example, a server) having an external database or the like, and downloading the application.

In navigation for a walking person, by displaying the narrow paths in a housing area on a display (not shown in the figures) that is installed in the mobile terminal apparatus S, it is possible to notify the user. Also, it is possible to provide location information regarding entrances, elevators, escalators and the like in large-scale shops such as department stores or shopping malls.

Moreover, the notification means is not limited to notification by a display apparatus, and it is possible to provide audio guidance by way of a small speaker.

Also, in navigation for an automobile and navigation for a motorcycle, it is often difficult to see a display that is located on the mobile terminal apparatus S, so a function is provided that gives audio guidance to the user by way of a small speaker or the like.

When executing navigation for an automobile, it is possible to make it impossible to receive a television signal or the like by the display of the mobile terminal apparatus. By making it impossible to watch television while driving, it is possible to provide support for enabling safe driving.

Next, the flowchart shown in FIG. 7 will be used to explain the operation of the mobile terminal apparatus of this embodiment.

In step S1, it is determined whether or not the mobile terminal apparatus S is connected to an external device. For example, it is determined whether or not the charge terminal of the mobile terminal apparatus is connected to an automobile or motorcycle as the means of travel. When the charge terminal of the mobile terminal apparatus S is connected to an automobile or motorcycle as the means of travel (step S1: YES), processing advances to step S8. When the charge terminal of the mobile terminal apparatus S is not connected to an automobile or motorcycle as the means of travel (step S1: NO), processing advances to step S2. Next, processing advances to step S2.

In step S2, state information that is output from the direction-sensor unit 2, temperature-sensor unit 3, air-pressure-sensor unit 4, inclination-sensor unit 5, gyro-sensor unit 7 as state-detection device is input to the system-control unit 1.

In step S3, based on the state information that was input to the system-control unit 1, the system-control unit 1 calculates the parameters for the mobile terminal apparatus S based on the column on the left side of FIG. 4. Based on the weighting information of FIG. 4, the system-control unit 1 assigns scores for an automobile, walking, a bicycle, a motorcycle and a train, or adds scores. Next, processing advances to step S4.

In step S4, based on the state information that was output from the GPS-sensor unit 7 and the map DB 8, the system control unit 1 determines the position of the mobile terminal apparatus S (map matching). Next, processing advances to step S5.

In step S5, based on items related to the position on the map of the mobile terminal apparatus S that was determined in step S4, and the position of the mobile terminal apparatus S in FIG. 5, the system-control unit 1 assigns or adds scores for an automobile, walking, a bicycle, a motorcycle and a train. Next, processing advances to step S6.

In step S6, the system-control unit 1 repeats step S3 and step S5 and determines how many times calculation has been performed. When the system-control unit 1 determines that calculation has been performed N times (for example, 10 times every second) (step S6: YES), the system-control unit 1 advances to step S7. When the system-control unit 1 determines that calculation has not been performed N times (for example, 20 times per second) (step S6: NO), the system-control unit 1 advances to step S2. Next, processing advances to step S7.

In step S7, the system-control unit 1 combines the weighted values for the total scores that were recorded in step S3 for an automobile, walking, a bicycle, a motorcycle and a train with the weighted values for the total scores that were recorded in step S5 for an automobile, walking, a bicycle, a motorcycle and a train to obtain total scores for an automobile, walking, a bicycle, a motorcycle and a train as candidates for the state of travel.

Moreover, the system control unit 1 determines that of the scores for the automobile, walking, bicycle, motorcycle and train, the candidate for the state of travel having the highest score is the state of travel of the mobile terminal apparatus S. Next, processing advances to step S8.

In step S8, the system-control unit 1 selects an application that corresponds to the state of travel of the mobile terminal apparatus S that was determined in step S7 or step S1, and executes that application.

In the embodiment described above, scoring was performed for an automobile, walking, a bicycle, a motorcycle and a train as candidates for the state of travel, and the state of travel was determined, however, scoring is not limited to these, and it is also possible to apply the present invention to an airplane, boat or the like as the state of travel.

The program that performs the operation corresponding to the flowchart in FIG. 7 is recorded beforehand on a flexible disc, or can be recorded beforehand by way of a network such as the Internet, and by reading and executing this program by a general-purpose microcomputer or the like, it is possible to make that general-purpose microcomputer function as the system-control unit 1 of this embodiment.

With this embodiment as described above, the mobile terminal apparatus is constructed so that it comprises a built-in sensor that is capable of detecting the oscillation mode, so it is possible to detect vertical oscillation (amplitude, period, etc.), forward, rear, left and right oscillation of the mobile terminal apparatus, as well as the inclination, change in direction, and amount of movement of the mobile terminal apparatus. Moreover, from these values it is possible to automatically determine the mode of travel (automobile, walking, bicycle, motorcycle, train, airplane, boat, etc.) of the mobile terminal apparatus.

Determining the means of travel based on the sensor output is performed by weighting each of the candidates for the means of travel according to the state of travel of the mobile terminal apparatus, changing scores over a predetermined period of time and totaling those scores, so it is possible to determine the means of travel more accurately.

Also, after these modes of travel have been determined, the mobile terminal apparatus is capable of selecting the most appropriate application for each mode of travel, and executing the appropriate application.

As a result, each time the means of travel that is moving the mobile terminal apparatus changes, it is possible to automatically perform navigation that corresponds to that means of travel.

Also, when the mobile terminal apparatus comprises internal map data, or when it is possible for the mobile terminal apparatus to received map data from the outside, construction is such that it is possible to determine the means of travel of the mobile terminal apparatus from the map data and the position information for the mobile terminal apparatus.

Determining the means of travel based on map data and position information for the mobile terminal apparatus is performed by weighting each of the candidates for the means of travel according to the location of travel of the mobile terminal apparatus, changing scores over a predetermined period of time and totaling those scores, so it is possible to determine the means of travel more accurately.

Therefore, each time the means of travel that is moving the mobile terminal apparatus changes according to the map data and position information of the mobile terminal apparatus, it becomes possible to automatically perform more accurate navigation that corresponds to that means of travel.

Furthermore, the mobile terminal apparatus combines determining the means of travel based on output from a sensor that is capable of detecting the oscillation mode, and determining the means of travel of the mobile terminal apparatus based on map data position information for the mobile terminal apparatus, so it is possible to more accurately determine the means of travel.

As a result, each time the means of travel that is moving the mobile terminal apparatus changes, it is possible to automatically perform more accurate navigation that corresponds to the means of travel.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2006-133592 filed on May 12, 2006 including the specification, claims, drawings and summary is incorporated herein by reference in its entirety.

What is claimed is:

1. A mobile terminal apparatus comprising:
a state-information-detection device for detecting state information about the mobile terminal apparatus;
a state-of-travel-judgment device for determining the state of travel of the mobile terminal apparatus based on state information that is detected by the state-information-detection device;
a guidance-information-judgment device for determining which guidance information is necessary for the mobile terminal apparatus based on the state of travel of the mobile terminal apparatus that is determined by the state-of-travel-judgment device; and
a notification device for notifying the mobile terminal apparatus of the guidance information that is determined to be necessary by the guidance-information-judgment device.

2. The mobile terminal apparatus of claim 1, wherein;
the state-of-travel-judgment device gives weighting to state information that is detected by the state-information-detection device for each of a plurality of predetermined state-of-travel candidates over a predetermined period of time, changes the numerical values for the state information based on the weightings, and then determines the state of travel of the mobile terminal apparatus to be the state-of-travel candidate having the largest numerical value.

3. The mobile terminal apparatus of claim 1, wherein;
the state-information-detection device comprises a plurality of state-information-detection units that detect state information; and
the state-of-travel-judgment device gives weighting to state information that is detected by the plurality of state-information-detection units for each of a plurality of predetermined state-of-travel candidates over a predetermined period of time, changes the numerical values for the state information based on the weightings, and then determines the state of travel of the mobile terminal apparatus to be the state-of-travel candidate having the largest numerical value.

4. The mobile terminal apparatus of claim 1, wherein;
the state-information-detection device comprises a position-information-detection unit that detects position information for the mobile terminal apparatus; and
the state-of-travel-judgment device identifies the location on a map of where the mobile terminal apparatus is located based on position information that is detected by the position-information-detection unit, and gives weighting to the position information based on the identified location on the map where the mobile terminal apparatus is located for each of a plurality of predetermined state-of-travel candidates over a predetermined period of time, changes the numerical values for the state information based on the weightings, and then determines the state of travel of the mobile terminal apparatus to be the state-of-travel candidate having the largest numerical value.

5. The mobile terminal apparatus of claim 2, wherein;
the state-information-detection device further comprises a position-information-detection unit that detects position information for the mobile terminal apparatus; and
the state-of-travel-judgment device identifies the location on a map of where the mobile terminal apparatus is located based on position information that is detected by the position-information-detection unit, and gives weighting to the position information based on the identified location on the map where the mobile terminal apparatus is located for each of a plurality of predetermined state-of-travel candidates over a predetermined period of time, changes the numerical values for the state information based on the weightings, calculates state-information values for which numerical values of the state information is changed, and calculates position-information values for which numerical values of the position information is changed, and then determines the state of travel of the mobile terminal apparatus to be the state-of-travel candidate having the largest numerical value for the calculated result.

6. A control method for a mobile terminal apparatus comprising:
a state-information-detection process of detecting state information about the mobile terminal apparatus;
a state-of-travel-judgment process of determining the state of travel of the mobile terminal apparatus based on state information that is detected by the state-information-detection step;
a guidance-information-judgment process of determining which guidance information is necessary for the mobile terminal apparatus based on the state of travel of the mobile terminal apparatus that is determined by the state-of-travel-judgment process; and
a notification step of notifying the mobile terminal apparatus of the guidance information that is determined to be necessary by the guidance-information-judgment process.

7. A control program for a mobile terminal apparatus that makes a computer that is included in the mobile terminal apparatus to function as:
a state-information-detection device for detecting state information about the mobile terminal apparatus;
a state-of-travel-judgment device for determining the state of travel of the mobile terminal apparatus based on state information that is detected by the state-information-detection device;
a guidance-information-judgment device for determining which guidance information is necessary for the mobile terminal apparatus based on the state of travel of the mobile terminal apparatus that is determined by the state-of-travel-judgment device; and
a notification device for notifying the mobile terminal apparatus of the guidance information that is determined to be necessary by the guidance-information-judgment device.

8. A recording medium on which the control program for a mobile terminal apparatus of claim 7 is recorded so that it can be read by a computer in the mobile terminal apparatus.
